(19) United States
(12) Patent Application Publication
(10) Pub. No.: US 2014/0052707 A1
(43) Pub. Date: Feb. 20, 2014

(54) Concierge Service System and Method

(71) Applicants: Lawrence F. Jindra, Floral Park, NY (US); Joseph F. Dolezal, Old Westbury, NY (US)

(72) Inventors: Lawrence F. Jindra, Floral Park, NY (US); Joseph F. Dolezal, Old Westbury, NY (US)

(21) Appl. No.: 13/986,480

(22) Filed: May 7, 2013

Related U.S. Application Data
(60) Provisional application No. 61/688,098, filed on May 8, 2012.

(51) Int. Cl. G06F 17/30

(52) U.S. Cl. CPC G06F 17/30864
USPC 707/707; 707/722

(57) ABSTRACT

A system and method is provided for conversion of information provided on public and/or private networks and managing that information by categories and offering services relating to that information; and particularly to a system and method for offering services related to maintaining an easy to use consumer site which searches golf courses and provides accurate tee time and other information related to golfing services and collects revenue based on those services.

### PRIORITY This application claims priority of U.S. Provisional Application Ser. No. 61/688,098, filed May 8, 2012

### BACKGROUND OF THE INVENTION

This invention relates to a system and method for conversion of information provided on public networks and managing that information by categories, and offering services relating to that information, and particularly to a system and method for offering an easy to use consumer site which searches golf courses and provides accurate tee time and other information related to golfing services.

There is an unmet consumer demand for an easy to use consumer site which can be adapted for different goods and/or services. For example there is an unmet need for an easy to use consumer site that searches golf courses to make golf reservations using a number of preferences such as location and provides easy to use, accurate tee time information, while also providing access to charity golf events which may not be readily accessible to the general public.

### SUMMARY OF THE INVENTION

The present invention provides a system and method wherein a user is enabled to log onto a web site having an interactive navigation system for searching and selecting tee time and associated golf course information. It can be appreciated that alternative embodiments of the invention can be adapted to include golf related apparel, equipment, and golf accessories. It can also be appreciated that alternative embodiments of the invention can also be adapted for concierge services for other services and goods in other market sectors, such as doctors, lawyers, restaurants, shoes, among other things.

In addition, in an embodiment of the invention, a transaction page can also be provided to enable a user to perform a secure transaction associated with the services on a selected website, such as purchasing a tee time reservation.

A system and method according to the invention can include searching the internet for public information related to golf courses and matching them to a user's requests and specifications. The user is provided with the ability to search by course, by date, by location, by price, among other things. The invention enables the user's selections to be quickly and efficiently matched with corresponding information provided by one or more courses. In addition, the system can permit the venue hosting the course to receive a secure on-line payment from the user.

In another embodiment, a system and method according to the invention includes providing a service to enable a user with access to and means to participate in charitable outings at private courses, which may not be completely open to the public or to non-members of the associated golf course or golf club. In addition to searching the internet for available outings which are hosted at such courses, the system can include an additional layer to enable the system to access private information by including a step of submitting access information, such as a user name and/or password, of an individual or entity with authorization to access the private information. The user is provided with the ability to search both the public and private information by course, by date, by location, by price, among other things. The invention enables the user's selections to be quickly and efficiently matched with corresponding information provided by one or more courses. In addition, the system can permit the venue hosting the course to receive a secure on-line payment from the user which may include a payment to a charity.

This model benefits the consumer, the charity, as well as the golf courses, all in a lock-on step fashion, driven by ease-of-use and high consumer satisfactions for the user. In addition to providing access to otherwise unfound donations, the system provides for increased profits to golf courses along with increased capacity utilization, and reduced advertising costs for the golf courses. In addition to providing access to unfound donations to the charity, the invention provides for a broadening of both the scope and breadth of the charities outreach.

In addition, the invention can include a payment systems wherein one or more of the user, the golf course, and/or the charitable organizations (as a golf outing organizers) is charged either a usage fee associated with the registering for the services provided by a system according to the invention or to transaction fee based upon a completed transaction with the golf course or charity. In addition, the invention can include the capture of user information and preferences, as well as targeted advertizing for one or more services chosen based upon one or more of the preferences chosen by a user. The system can include tracking of transactions consummated by a user for use with charging targeted advertising. For example, in one embodiment, the service can charge a brokerage fee to the user, a subscription fee from the courses, and/or generate advertising revenue based.

Specific examples are included in the following description for purposes of clarity, but various details can be changed within the scope of the present invention.

### OBJECTS OF THE INVENTION

An object of the invention is to provide a system and method of searching public and privately available information associated with goods and/or services and to make offerings associated with those goods and or services available to users and to satisfy an unmet consumer demand for those good and/or services. More specifically, it is an object of the invention to provide a system and method of searching public and privately available information associated with tee times and charity golf outings and to make offerings associated with golfing opportunities available to golfers and golf planning agents.

Another object of the invention is to provide an improved and user-friendly, internet navigation and search for user activity, serve as a broker of such activities and services, and to supply a transaction service providing, in real time, such services to the consumer and ensuring the secure delivery of funds to the merchant, supplier, or business. It is a further object of the invention to provide a system which can be supported by providing advertisers with customized demographic user information along with quantified site visit data.

It is a further object of the invention to provide a sleek, interactive, and easy-to-use consumer web page and mobile device (i.e., phone or tablet) application for providing access to goods and/or services which may not be readily available to the public.

Another object of the invention is to provide a seamless and transparent behind-the-scenes internet navigation and web search, which includes a secure, interactive, and consumer-friendly transaction page, and which can scale up in breadth and depth for one or more services and/or goods. Another object of the invention is to provide such system which can be further scaled geographically, from local venues to other national venues and on to international venues. Another object of the invention is to provide such system which can be further scaled horizontally across products and/or services, from products and services that are related by type, to products and services related by geography, and/or from products and services that are related by type, to products and services related by relative pricing categories, among other things.

Other and further objects of the invention will become apparent with an understanding of the following detailed description of the invention or upon employment of the invention.

### BRIEF DESCRIPTION OF THE DRAWINGS

A preferred embodiment of the invention has been chosen for detailed description to enable those having ordinary skill in the art to which the invention appertains to readily understand how to construct and use the invention and is shown in the accompanying drawing in which:

FIG. 1 is a diagram representing one or more search pages provided by an embodiment a concierge service system and method according to the invention.

FIGS. 2a, 2b and 2c represent one or more search results pages provided by an embodiment a system and method according to the invention.

FIG. 3 is a schematic diagram of a modified embodiment of a process for a concierge service system according to the invention.

FIG. 4 is a schematic diagram of a concierge service system according to the invention.

### DETAILED DESCRIPTION

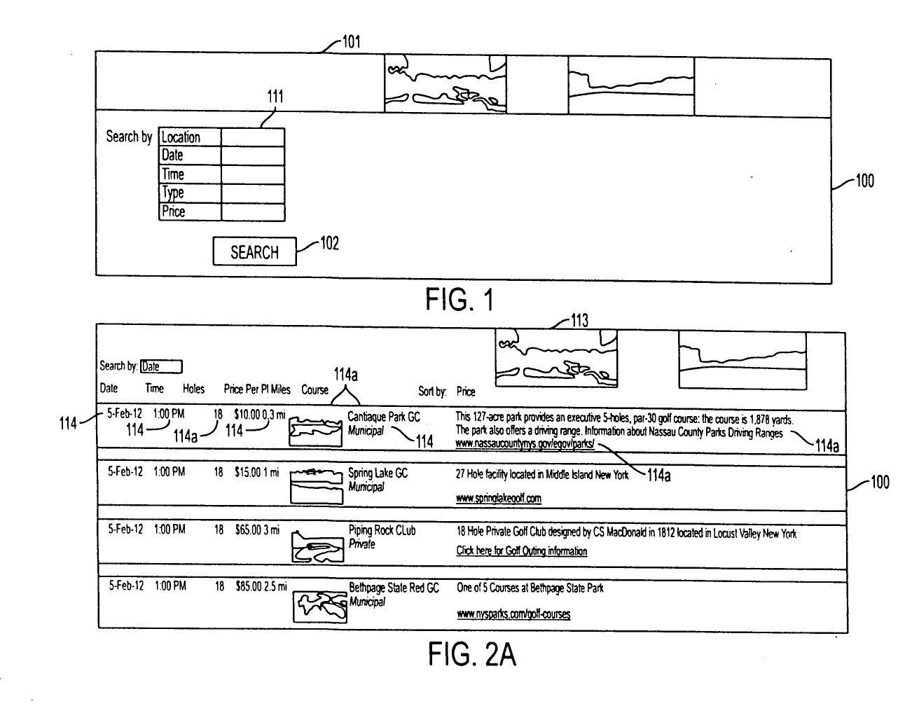

Referring to the drawing of FIG. 1, a concierge service system and method 100 according to the present invention is directed to a preferred embodiment which includes programming to provide an interface 101 that is provided for selection of one or more categories of search criteria 110 associated with a particular, good or service. For example, the interface 101 can include a home page. In the preferred embodiment, the categories of search criteria 110 are associated with certain public and private golf courses and golf outings. The categories of search criteria 110 are selected through one or more processes described more fully within.

In one embodiment, the system and method 100 also includes programming to permit a user to enter one ore more search criteria 111 appropriate for a category of search criteria 110. In addition, or in the alternative, the system can present one or more pre-determined search criteria 111 which are predetermined by the system as being appropriate for each category 110. For example, a customer can search by location, date, time, type of course, and price to play from the homepage. The processes by which the system determines the search criteria 111 that can be selected are described more fully within. For example, a user may select from auto-complete fill-in fields as the user enters information which will allow the system to present the user with the desired information faster, more efficiently, and in a format which will be both more helpful and more useful to the user. Once a user has entered and/or selected one or more search criteria 111, the user can request a search to be performed 102.

In a preferred embodiment, the system and method 100 also includes programming to search according to one or more search criteria provided by a user. In addition or in the alternative, the system may include one or more additional predetermined criteria 112 to perform the search. Predetermined criteria 112 can include criteria based on saved user preferences associated with the user, or saved user preferences of a different user such as a concierge at a hotel who may have a predetermined list of venues with whom the hotel may have a preexisting business relationship, and/or additional predetermined system preferences which have been predetermined by the system to facilitate a search, such as national or local location information to narrow the search to terms a system administrator may deem pertinent to the users of the system. As an example of preexisting business relationships, a user may have knowledge of and or access to seasonal promotions, charity events, and or membership information which is not available to the public. As an example of predetermined system preferences, a system customized for the tri-state area near New York City in the United States may specifically limit its searches to the states of New York, New. Jersey, and Connecticut, and/or to municipal and public courses.

Accordingly, in one embodiment customized for searching golf courses, a user will desire to search by location date time type of course, and price to play form the homepage. They may fill in as fields as they choose which will allow them to be presented with the desired information faster, more efficiently, and in a format which will be both more helpful and more useful to the user. This is one of the initial steps to start the search and/or internet search and web crawling process. It can be appreciated that a system according to the invention can be adapted for use with goods and/or services other than golf course reservations.

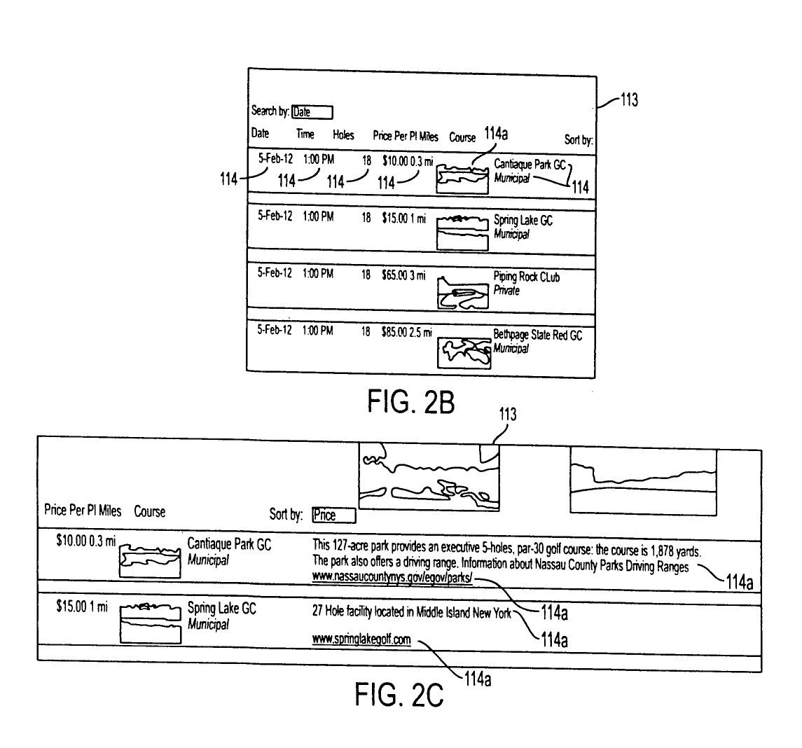

Referring to the drawing of FIG. 2a, once a search is performed a preferred embodiment of the system can display and/or send one or more search results 113. The search results can include one or more fields of search information 114 related to the search criteria 111 and/or predetermined search criteria 112. The search information can include other information associated with the search not specified in the search criteria. For example, in addition to search criteria such as “location,” “date,” “time,” “type,” and “Price,” additional information 114a such as an image, a hyperlink, and/or textual description can also be included. In addition, the system can generate other information from other sources which may or may not be not specifically provided by the target of the search, such as driving directions to the golf course, course data, local information e.g., pro shop contact information, outing prices, such as for comparison purposes, and/or outing availability (on hard to access courses) which are open to the public via outings, golf course links, and/or catering links for golf outings, weddings, parties, and/or fund-raisers.

As shown in FIGS. 2b and 2c, if the initial search is for a particular date, such as for Feb. 2, 2012, a list will be presented showing available golf tee times of that day. In an embodiment of the invention customized for golf courses, the system includes programming to permit a user to fine tune their search. As another example, an embodiment of a system according to the invention can include programming to perform further searches and sorting, such as by price, in order to find the result (in this case golf course) that better matches the users need. The results list can be sorted again, by providing programming which enables the user to further select and/or fill-in fields to narrow the search down in accordance with the user's needs.

In an alternative embodiment of a system and method according to the invention, programming can also be provided to perform an initial search according to one or more sets of predetermined criteria. In one embodiment of the invention a plurality of criteria sets can be provided related to a category of goods or services. For example, in an embodiment of the invention adapted for golf services, one predetermined criteria set can include generally unavailable, unpublished and difficult to search golf outings in a specific geographic and/or municipal area such as Nassau county in New York. Therein, either web crawling and/or one or more internet searching algorithms can be used to search among civic, fraternal and/or service clubs.

An embodiment of a system and method according to the invention includes programming to store the search criteria, any predetermined criteria set, and any user input criteria. In addition, programming is provided to store search results associated with the criteria in a database. Programming can also be provided to build a unique profile associated with the user and search criteria associated with the user.

In addition, the system can include programming to save the search results in a separate database for access in future searches which can be used to optimize the search process, to more uniquely and more specifically meet each user's needs or the perceived needs of like users.

In a further embodiment of a system and method according to the invention, programming is provided to perform one or periodic update searches based on one or more search criteria, predetermined criteria sets and or saved user criteria.

An embodiment of a system according to the invention adapted for searching golf courses can include programming to perform at least the following: programming to permit a user to separate and search private or public courses; programming to permit a user to find available tee times and make reservations; programming to permit a user to determine the location of and directions to one or more golf courses; programming to permit a user to receive prices for a round of golf within the customer's budget; programming to permit a user to received either brief or verbose descriptive information about one or more selected golf courses; programming to permit a user to display helpful contact information phone numbers and website links; programming to permit a user to receive photos and/or images of selected golf courses along with course maps; yardage books and a score card; programming to permit a user to find outing costs with links to sponsoring charity websites; programming to permit a user to find course architects and designers, among other things.

Accordingly, a system according to the invention can permit a user to visit, browse, and use the system to find information currently already available on the internet and/or stored on the system. Although the search results may only contain partial content of available information, by presenting the information in a partial content the system presents the information in on one user friendly and easy to use website. An embodiment of a system according to the invention can permit a user to use the system as a tool to navigate through golf course information, to save valuable personal and computer time, to connect them to data they desire or require, and to provide them with the answers they seek and would otherwise need hours to discover, to price together and/or to receive.

Alternative embodiments of a system according to the invention adapted for searching golf courses can also include programming to provide one or more semi-autonomous configurations or combinations to permit the system and method to perform more or less stand alone. For example, in one embodiment the of the invention the system includes programming to a complete search maneuver each time it is requested by a user and search criteria entered by a user can be sent by the system to an internet site returned from a search result to provide information associated with the sent criteria. Thereafter the system can directly link a user to the internet site associated with the golf course selected from the search result. In addition or in an alternative embodiment, the system includes programming to wait for a defined period to ensure confirmation from the target internet site before sending a link to the user. For example, after executing a sub-search on target internet site, the system can include programming to wait for results of the sub-search performed by the target Internet site. Similarly, a further embodiment of the system can include programming to permit a user to securely submit payment information to make a reservation at the golf course. Accordingly, a further embodiment of a system according to the invention includes programming to wait for a period of time, such as either a predetermined period of time, or upon receiving confirmation from the target internet site to which the payment has been submitted before the informing the user and/or billing the user for use of the system.

Alternative embodiments of a system according to the invention adapted for searching golf courses also include programming to save data that has been retrieved from one or more searches by a user which data is saved in a database with information associated with a user, and programming to make all or part of such data available to the user by the system. Accordingly, the system permits a user to access saved information for requesting the tee times, providing directions, dress code information and other pertinent information available to protect against miscommunication of the selected reservation and tee times.

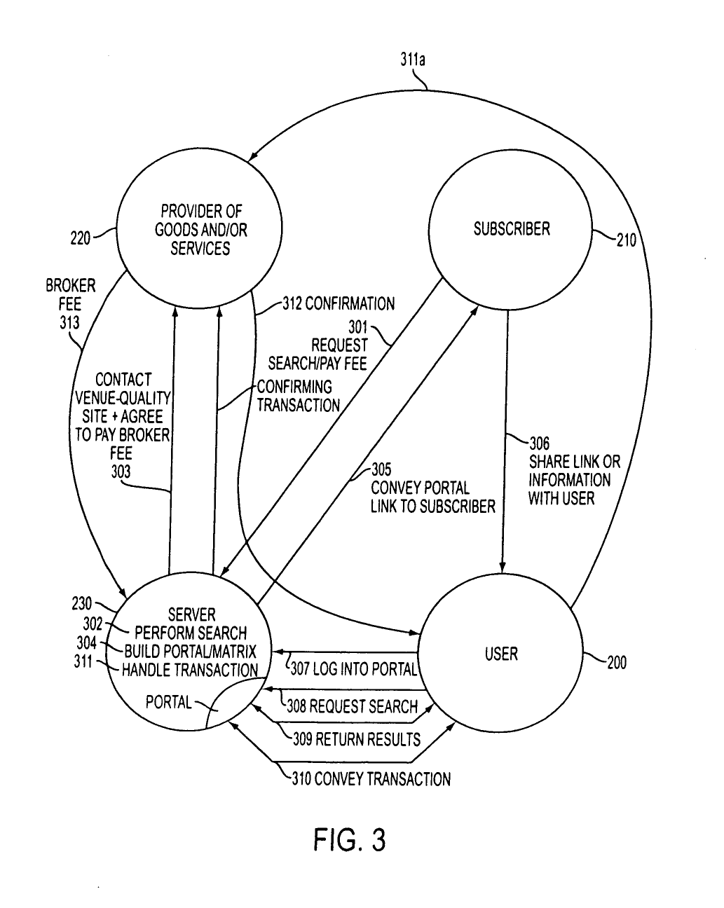

FIG. 3 shows an alternative embodiment of a method and system according to the invention having one or more steps or processes that can be included in or as one or more the above-described systems and methods. It can be appreciated that one or more the steps can be performed in an order other than the order or sequence as described herein. In FIG. 3, lines of communication are shown linking a user 200, subscriber 210, provider of goods and/or services 220 and a concierge server 230 for a concierge service system according to the invention.

In a first step 301, a user 200 or subscriber 210 requests a search. In the case of a user, the user may request the search directly from either the server 230 or a subscriber 210.

In one embodiment of the invention, programming is provided so that in the event a subscriber 210 requests a search from the server 230, the server 230 determines whether or not the subscriber 210 has subscribed to receive services from the server 230. In addition, programming can be provided for the server to securely accept payment from the subscriber for use of one or more of the services provided by the server 230. For example, a vacation resort can subscribe to a service which locates golf outings, destinations and golf packages in an area relevant to the vacation resort and provides that information to the vacation resort for a per use, periodic or other subscription fee.

In a further or second step 302, the server 230 performs a search according to one or more criteria associated with the subscriber 210 or user 200. The server 230 includes programming to save the results of the search which include one or more providers of goods and/or services 220.

In one alternative embodiment of the invention, the server 230 includes programming and/or performs a third or additional step 303 of contacting a provider of the goods or services to determine whether the provider 220 is qualified and/or meets the criteria desired by the server 230 and/or determines whether or not the provider 230 agrees to pay a fee for the server 230 to direct potential customers of the provider 220 to the provider 220.

In another or fourth step 304, the server 230 saves the information associated with the provider in a database and/or matrix. In addition or in the alternative, the server 230 builds a portal through which a user can access the provider's goods and/or services by communication first directly through the server. In a further or fifth step 305, the server 230 communicates a portal link or information associated with the provider's goods and/or services to the subscriber 210 and/or user 200. In an embodiment of the subscriber receiving the information, the subscriber can additionally communicate the link and or provider information to a user 200 in a further or sixth step 306.

In a further or seventh step 307 according to the invention, a user 200 is enabled to log into the server 230 such as by using a link and upon logging in the user can access a search request and/or search result information. In a further step, the server 230 can perform a new search or retrieve saved search information to the user 309. Upon receiving the search information from the server 230, in a further step 310 a user 200 can convey transaction information associated with the search. For example, a user can provide to the server 230 information to make a golf tee time reservation and/or purchase golf shoes.

Upon receiving the user's transaction information, the server can handle the transaction between the provider 220 and the user 200. In an alternative step 311a according to an embodiment of the invention, the transaction is handled between the user and the provider. Upon consummation of the transaction by the provider 220, confirmation information can be sent to the user 312.

In an additional optional step 313, the server 230 can request and/or receive a fee from the provider 220 which fee is associated with the transaction consummated between the user 200 and the provider 200.

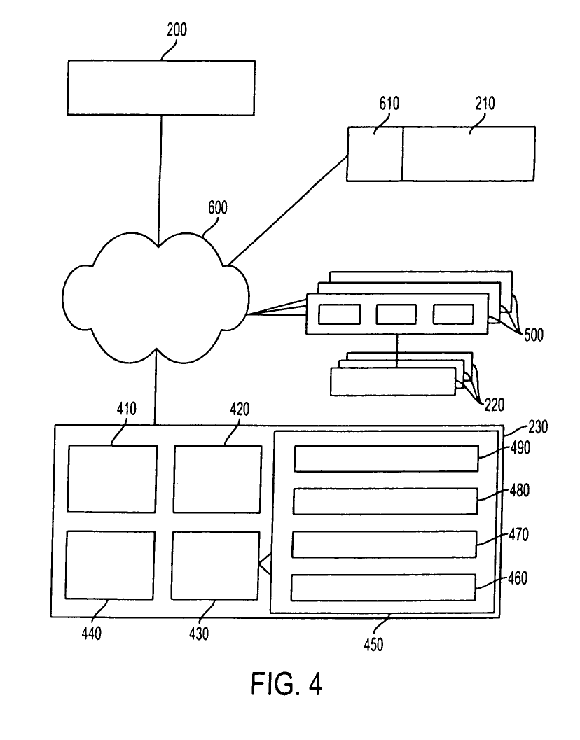

FIG. 4 illustrates a schematic view of a concierge service system according to the invention in which a server 230 is in communication with a communications network 600, such as the Internet, to which are also communicatively connected one or more users 200, one or more subscribers 210, and one or more providers 200 each having an associated website 500 which may be a target of one or more searches of the system.

The system comprises a server 230 having a processor 410, a communications port 420 such as an internet modem, memory 430 and at least one user command interface 440, such as a touch screen, mouse and/or keyboard. In addition, the server 230 includes server programming 450 for performing one or more of the steps and for functions described above with respect to FIGS. 1-3, which can include including programming for network communications, database management, a user interface, server home page, server search page, subscriber portal internet page, provider portal internet page among other things.

Specifically, the programming includes one ore more databases or matrices 460 for storage of criteria, search results, and/or user and subscriber information. In addition, or in the alternative, one or more databases 460 can be provided for storage of subscription fee information for managing payments by a subscriber 210 for use of the server. In addition, or in the alternative, one or more databases 460 can be provided for storage of referral and/or broker fee information for managing payments by a users 200 and/or providers 220 for consummated transactions.

In addition, the server programming 450 includes programming for one or more search engine programming 470 which search engine programming 470 can be either a stand-alone search engine or alternatively be programming to effect a search through a third party search engine which is not part of the system. The search engine programming includes programming to effect the above described functions related to the searches described above with respect to FIGS. 1-3, including use of user criteria, predetermined criteria, and subscriber criteria among other things.

Furthermore, the server programming 450 includes programming for one or more portals 480 which portals 480 can be include a link to an third party website, such as a provider website 500 associated with a provider 220 and/or programming to emulate portions of a provider website 500 related to the transaction details pertinent to the search. For example, instead of providing all the information that may be available on a provider website 500, select information such as search information 114 associated with a provider 220 can be programmed for display as shown in FIGS. 1-2.

In an alternative embodiment of the invention, the server programming 450 can include programming for a portal builder 490 for providing at least a semi-automated retrieval of criteria information and search results from third party websites, such as a provider website 500 associated with a provider 220. The portal builder 490 includes one or more keywords associated with at least one criteria, which keywords are used for searching within the hypertext markup language of a search target website 500 associated with a provider 220. When there is a match of a keyword for a criteria with a form field on the target website 500 associated with the keyword, the portal builder 490 can store a link associated with that form field. For example in an embodiment customized for golf services, as shown in FIGS. 1-2, a tee time can be entered by a user into a tee-time search field on a search page of a portal maintained by the system. When the tee time is entered, the system can query the target website 500 of a provider 220 by inserting the tee time information into the form field stored by the portal builder 490.

In an alternative embodiment of a system according to the invention, the system can include client programming 610 which can be provided to a subscriber 220 of the services provided by the system. The client programming 610 can include programming to perform one or more of the above-described functions of the programming of the server 230. Among other things, the client programming 610 can include a programming for a subscriber portal customized for the goods and/or services desired by a subscriber 210. For example, a subscriber 210 may be a resort which desired a simplified portal for its guests or users 200 to access one or more goods and/or services associated with the resort, including golf, tennis, restaurants and shopping. Accordingly, the client programming 610 can include programming for separate portals tailored for searching criteria relevant for golf, tennis, restaurants and shopping.

The foregoing merely illustrates the principles of the invention. It will thus be appreciated that those skilled in the art will be able to devise various arrangements which, although not explicitly described or shown herein, embody the principles of the invention and are thus within its spirit and scope. For example, a specified embodiment described herein related to golf can be alternative adapted for or included with other good and or services, such as tennis, restaurants, shoes, among other things.

I claim:

1. A method of conducting a search over a communications network comprising the steps of:
receiving a subscription from a subscriber;
receiving at least one predetermined search criteria and at least one subscriber search criteria;
searching for at least one provider based on at least one of the predetermined search criteria and the subscriber search criteria;
contacting at least one provider and qualifying said at least one provider;
storing at least one search result associated with the predetermined search criteria and subscriber search criteria in a stored database, said search result including provider information; and
communicating portal link information to the subscriber.

2. The method according to claim 1 further comprising the steps of:
receiving a login request to the portal link from a user;
receiving a user search request through the portal link from a user;
performing a user search based on the search request; said user search being selected from the group comprising a search of the internet and a search of the stored database, said user search returning at least one user search result; and
communicating said user search result to the user.

3. The method according to claim 2 further comprising the steps of:
receiving a user transaction request from the user; said user transaction request being associated with the user search result;
handling the user transaction request with a provider associated with the user search result.

4. The method according to claim 3 further comprising the steps of:
receiving a fee from the subscriber associated with the subscription.

5. The method according to claim 3 further comprising the steps of:
receiving a fee from the provider associated with the user transaction.
